(19) United States
(12) Patent Application Publication
(10) Pub. No.: US 2026/0336554 A1
(43) Pub. Date: Oct. 29, 2026

(54) VEHICLE POWER SUPPLY SYSTEM

(71) Applicant: SUBARU CORPORATION, Tokyo (JP)

(72) Inventor: Takahiro KINOSHITA, Tokyo (JP)

(21) Appl. No.: 19/716,957

(22) Filed: Jun. 23, 2026

Related U.S. Application Data
(63) Continuation of application No. PCT/JP2024/005477, filed on Feb. 16, 2024.

(51) Int. Cl. B60R 21/017; B60R 16/033; H02J 7/00; H02J 7/60

(52) U.S. Cl. CPC B60R 21/017; B60R 16/033; H02J 7/663; H02J 7/855

(57) ABSTRACT

A vehicle power supply system includes: an auxiliary-device battery provided as a power source for an auxiliary device group in a vehicle; a relay interposed between the auxiliary-device battery and the auxiliary device group; a controller configured to turn off the relay in accordance with a decrease in a battery level remaining in the auxiliary-device battery and perform capacity-decrease cutoff control comprising cutting off power supply from the auxiliary-device battery to the auxiliary device group; and a switch switchable between an on mode and an off mode. The controller is configured to turn on the relay when the switch is detected as being switched on in a state where the relay is off. The switch is configured to be switched between the on mode and the off mode by inserting and removing a fuse into and out from a terminal unit provided in a fuse box of the vehicle.

### CROSS-REFERENCE TO RELATED APPLICATIONS

This application is continuation of International Application No. PCT/JP 2024/005477, filed on Feb. 16, 2024, the entire contents of which are hereby incorporated by reference.

### BACKGROUND

The disclosure relates to the technical field of vehicle power supply systems equipped with batteries for supplying electric power to auxiliary device groups in vehicles.

The use of lithium-ion batteries as an alternative to 12-V lead batteries for auxiliary devices is being studied.

An example of related art is Japanese Unexamined Patent Application Publication (JP-A) No. 2022-167433. JP-A No. 2022-167433 discloses a technology for enhancing vehicle safety by ensuring power supply in an emergency situation, such as a vehicle crash.

### SUMMARY

An aspect of the disclosure provides a vehicle power supply system including an auxiliary-device battery, a relay, a controller, and a switch. The auxiliary-device battery is provided as a power source for an auxiliary device group in a vehicle. The relay is interposed between the auxiliary-device battery and the auxiliary device group. The controller is configured to turn off the relay in accordance with a decrease in a battery level remaining in the auxiliary-device battery and perform capacity-decrease cutoff control including cutting off power supply from the auxiliary-device battery to the auxiliary device group. The switch is switchable between an on mode and an off mode. The controller is configured to turn on the relay when the switch is detected as being switched on in a state where the relay is off. The switch is configured to be switched between the on mode and the off mode by inserting and removing a fuse into and out from a terminal unit provided in a fuse box of the vehicle.

An aspect of the disclosure provides a vehicle power supply system including an auxiliary-device battery, a relay, a switch, and circuitry. The auxiliary-device battery is provided as a power source for an auxiliary device group in a vehicle. The relay is interposed between the auxiliary-device battery and the auxiliary device group. The switch is switchable between an on mode and an off mode, and is configured to be switched between the on mode and the off mode by inserting and removing a fuse into and out from a terminal unit provided in a fuse box of the vehicle. The circuitry is configured to turn off the relay in accordance with a decrease in a battery level remaining in the auxiliary-device battery and perform capacity-decrease cutoff control including cutting off power supply from the auxiliary-device battery to the auxiliary device group. The circuitry is configured to turn on the relay when the switch is detected as being switched on in a state where the relay is off.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to describe the principles of the disclosure.

FIG. 1 illustrates a substantially internal configuration example of a vehicle equipped with a vehicle power supply system according to an embodiment;

FIG. 2 illustrates a configuration example of the vehicle power supply system;

FIG. 3 is a flowchart of a process by a controller included in the vehicle power supply system; and

FIG. 4 illustrates another configuration example of a switch.

### DETAILED DESCRIPTION

When a lithium-ion battery is used as an auxiliary-device battery, the behavior in the event of a dead battery is different from when a lead battery is used.

In the case of the lithium-ion battery, a control circuit called a battery management system (BMS) is installed for protecting the battery cell. When the state-of-charge (SOC) as the remaining battery level decreases without the battery cell being charged due to a certain situation, a relay function (called a system main relay (SMR)) for automatically cutting off the electric power is implemented for preventing an irreversibly non-reusable situation.

However, depending on the SMR function, the electric power of the auxiliary device group including various vehicle-mounted electric control units (ECUs) becomes lost, thus causing the vehicle to become non-restartable even if a repair or recharging is desired. In this case, a diagnostic device also becomes non-usable since the power source of the auxiliary device group is lost.

Therefore, when the lithium-ion battery is to be reused by being recharged, a countermeasure is to be taken. The countermeasure may include transmitting a reactivation command to the BMS by coupling an additional power source to the vehicle to enable power supply to the diagnostic device, transmitting a reactivation command to the BMS in a power suppliable environment by removing the lithium-ion battery if there is no additional power source near the vehicle, or replacing the lithium-ion battery with a new one. This complicates the process and leads to an increase in repair cost.

It is desirable to prevent the countermeasure against a dead battery from being complicated even when a lithium-ion battery is provided as an auxiliary-device battery, and to prevent reduced maintainability relative to when a lead battery in the related art is used.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

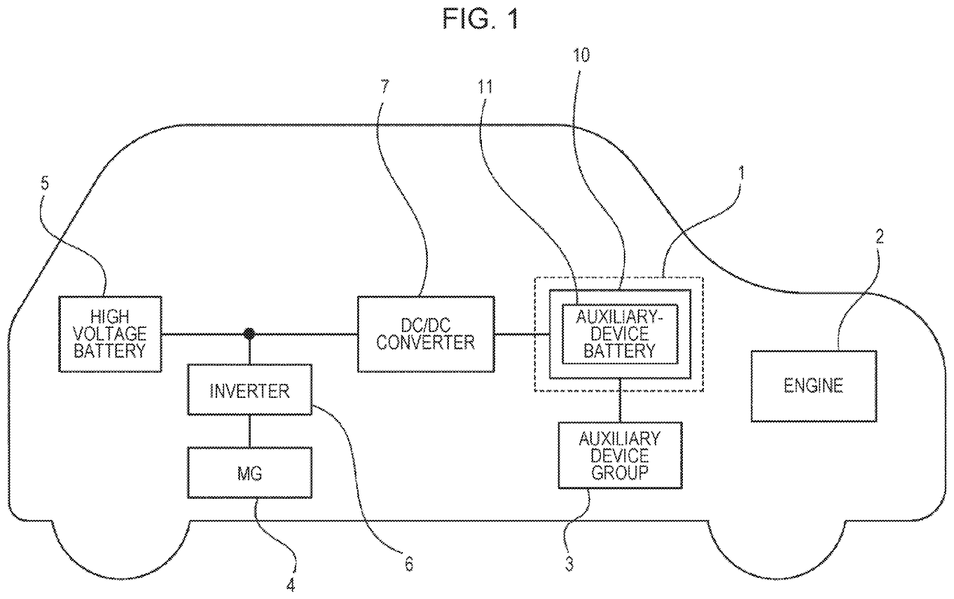

FIG. 1 illustrates a substantially internal configuration example of a vehicle equipped with a vehicle power supply system 1 according to an embodiment.

Components according to the embodiment of the disclosure illustrated in FIG. 1 are extracted from various components that the vehicle according to the embodiment has.

The vehicle according to the embodiment is a hybrid electric vehicle (HEV) equipped with an engine 2 and a motor generator (MG) 4, and includes a high voltage battery 5 (drive battery) for providing driving power of the MG 4.

In the vehicle serving as an HEV, the engine 2 may be used as a driving source for the wheels, or may be used as a power source for generating driving power of the MG 4 or electric power for charging the high voltage battery 5.

In this example, the vehicle is assumed as being a four-wheeled vehicle. Alternatively, the vehicle according to the embodiment may be a vehicle having two or more wheels.

The vehicle is provided with an inverter 6 for the MG 4. The inverter 6 outputs a driving voltage generated based on an input voltage from the high voltage battery 5 to the MG 4 during a power running mode of the MG 4, and charges the high voltage battery 5 using regenerative electric power generated by the MG 4 during a regenerative mode.

The vehicle also includes an auxiliary device group 3. The auxiliary device group 3 widely includes various electronic components, such as an electronic throttle and a fuel injector for actuating the engine 2, various electric control units (ECUs) for performing various types of operation control, such as control of the engine 2 and the MG 4, on the vehicle, and vehicle-mounted electronic devices, such as a meter, a navigation device, and an audio device.

The vehicle power supply system 1 has an auxiliary-device battery unit 10 for supplying electric power to such an auxiliary device group 3.

The auxiliary-device battery unit 10 has an auxiliary-device battery 11 provided as a power source for the auxiliary device group 3. In this example, a rated output voltage of the auxiliary-device battery 11 is 12 V. The rated output voltage of the auxiliary-device battery 11 may sometimes be, for example, 24 V, and is not limited to 12 V.

The rated output voltage of the auxiliary-device battery 11 is lower than the rated output voltage (e.g., 400 V) of the high voltage battery 5.

In the vehicle power supply system 1 according to the embodiment, the auxiliary-device battery 11 used is a lithium-ion battery instead of a lead battery. A lithium-ion battery can be reduced in battery weight and size, as compared with a lead battery, and may thus contribute to a reduced vehicle weight and a reduced mounting space.

In the vehicle according to the embodiment, the auxiliary-device battery 11 can be charged by the high voltage battery 5. When the auxiliary-device battery 11 is to be charged by the high voltage battery 5, a DC/DC converter 7 is used.

The DC/DC converter 7 has a step-down function and lowers the input voltage from the high voltage battery 5 (to 12 V in this example) and outputs the voltage to the auxiliary-device battery unit 10, thereby charging the auxiliary-device battery 11.

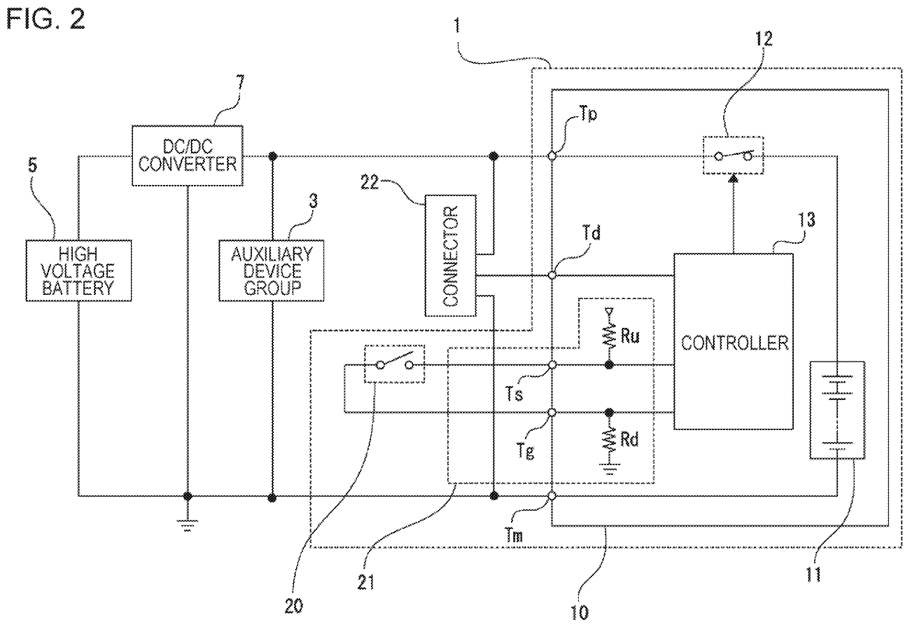

FIG. 2 illustrates a configuration example of the vehicle power supply system 1.

In FIG. 2, the auxiliary device group 3, the high voltage battery 5, and the DC/DC converter 7 illustrated in FIG. 1 are illustrated together with the configuration example of the vehicle power supply system 1.

A connector 22 illustrated in FIG. 2 has various terminals to be coupled to a diagnostic device, and is a connector for a controller area network (CAN) in this example. When the connector 22 is coupled to a CAN communication device, such as a diagnostic device, electric power can be supplied from the vehicle power supply system 1 toward the communication device via the connector 22.

As illustrated in FIG. 2, the vehicle power supply system 1 includes a switch 20 in addition to the auxiliary-device battery unit 10.

The auxiliary-device battery unit 10 has a relay 12 and a controller 13 in addition to the auxiliary-device battery 11. The auxiliary-device battery unit 10 has a positive terminal Tp, a negative terminal Tm, a data terminal Td, a switch signal terminal Ts, and a ground (GND) terminal Tg as terminals.

As illustrated in FIG. 2, the auxiliary device group 3 is disposed outside the auxiliary-device battery unit 10 and is interposed between the positive terminal Tp and the negative terminal Tm coupled to ground.

The DC/DC converter 7 and the high voltage battery 5 are similarly interposed between the positive terminal Tp and the negative terminal Tm.

In the auxiliary-device battery unit 10, a series-coupled circuit between the relay 12 and the auxiliary-device battery 11 is interposed between the positive terminal Tp and the negative terminal Tm.

The relay 12 is an electromagnetic relay that undergoes on/off switch control performed by the controller 13.

When the relay 12 is turned on, the auxiliary-device battery 11 and the positive terminal Tp are electrically coupled to each other, so that electric power of the auxiliary-device battery 11 can be supplied to the auxiliary device group 3. With the auxiliary-device battery 11 and the positive terminal Tp being electrically coupled to each other, the high voltage battery 5 can be charged with the electric power of the auxiliary-device battery 11 via the DC/DC converter 7.

In contrast, when the relay 12 is turned off, the auxiliary-device battery 11 and the positive terminal Tp are electrically uncoupled from each other, so that the electric power from the auxiliary-device battery 11 is not suppliable to the auxiliary device group 3. Moreover, the auxiliary-device battery 11 is not chargeable by the high voltage battery 5.

The controller 13 includes a microcomputer having, for example, a central processing unit (CPU), a read-only memory (ROM), and a random access memory (RAM). The CPU executes various processes in accordance with a program stored in the ROM, thereby performing various types of control related to the auxiliary-device battery unit 10.

Although not illustrated, the controller 13 is supplied with the electric power from the auxiliary-device battery 11.

The controller 13 is capable of performing data communication with an external device, such as the diagnostic device coupled to the connector 22, via the data terminal Td. The controller 13 is also capable of performing data communication with a vehicle-mounted ECU (not illustrated) via the data terminal Td.

The controller 13 is capable of executing a process based on a command from the outside, such as a command output from the diagnostic device.

The controller 13 has a status monitoring function for the auxiliary-device battery 11. For example, the controller 13 is capable of monitoring the output voltage value, the output current value, and the battery temperature of the auxiliary-device battery 11, as well as calculating the state-of-charge (SOC) and the state-of-health (SOH).

The controller 13 also controls the relay 12 based on a monitored status result of the auxiliary-device battery 11. In detail, the controller 13 according to this embodiment controls the relay 12 to an off mode in accordance with a decrease in the battery level remaining in the auxiliary-device battery 11 and performs capacity-decrease cutoff control for cutting off the power supply from the auxiliary-device battery 11 to the auxiliary device group 3. For example, the controller 13 controls the relay 12 to the off mode when the SOC of the auxiliary-device battery 11 is detected as being lower than or equal to a predetermined threshold value.

A condition for turning off the relay 12 with respect to the capacity-decrease cutoff control is not limited to the condition where the SOC becomes lower than or equal to the predetermined threshold value. For example, other conditions may be set, such as a condition where a temporal element is incorporated such that a state where the SOC is lower than or equal to the predetermined threshold value lapses for a predetermined time period or longer or a condition where the degree of frequency is incorporated such that the number of times the SOC becomes lower than or equal to a fixed value per unit time becomes greater than or equal to a predetermined value.

With the capacity-decrease cutoff control performed as described above, when a lithium-ion battery is used as the auxiliary-device battery 11, a situation where the auxiliary-device battery 11 becomes irreversibly non-reusable can be prevented.

Depending on the capacity-decrease cutoff control described above, the electric power of the auxiliary device group 3 including various vehicle-mounted electric control units (ECUs) becomes lost, thus causing the vehicle to become non-restartable even if a repair or recharging is desired (in this case, the diagnostic device also becomes non-usable since the power source of the auxiliary device group 3 is lost).

Therefore, when the auxiliary-device battery 11 is to be reused by being recharged, a countermeasure is to be taken. The countermeasure may include transmitting a reactivation command to the controller 13 by coupling an additional power source to the vehicle to enable power supply to the diagnostic device, transmitting a reactivation command to the controller 13 in a power suppliable environment by removing the auxiliary-device battery unit 10 if there is no additional power source near the vehicle, or replacing the auxiliary-device battery unit 10 with a new one. This complicates the process and leads to an increase in repair cost.

In this embodiment, the switch 20 switchable between an on mode and an off mode by being operated is provided, and the controller 13 performs control for turning on the relay 12 when the switch 20 is detected as being in the on mode in a state where the relay 12 is in the off mode.

Accordingly, even when the power supply to the auxiliary device group 3 is stopped in accordance with the capacity-decrease cutoff control for protecting the auxiliary-device battery 11, the relay 12 is forcibly turned on when the switch 20 is switched on by the user, whereby electric power can be supplied to the auxiliary device group 3.

When electric power can be supplied to the auxiliary device group 3, the system is activated, and the auxiliary-device battery 11 becomes chargeable by the high voltage battery 5, so that the power supply from the auxiliary-device battery 11 to the auxiliary device group 3 can be continuously performed as usual. In one example, as a countermeasure against a dead battery in this case, the user can simply switch on the switch 20.

Accordingly, even when a lithium-ion battery is provided as the auxiliary-device battery 11, the countermeasure against a dead battery can be prevented from being complicated.

The switch 20 may be a physical switch provided at a predetermined location of the vehicle. Examples of the physical switch include a push-button switch, a knob switch, a slide switch, and a dial switch.

Alternatively, the switch 20 may conceivably be a virtual switch provided by a graphical user interface (GUI).

In either case, the switch 20 may conceivably be a toggle switch switchable from the off mode to the on mode and from the on mode to the off mode.

The vehicle power supply system 1 has a switch-signal supply unit 21 for supplying a switch signal indicating the on mode or the off mode of the switch 20 to the controller 13.

As illustrated in FIG. 2, one of the terminals of the switch 20 is coupled to the controller 13 via the switch signal terminal Ts. A line coupling the one terminal of the switch 20 to the controller 13 via the switch signal terminal Ts will be defined as a switch-signal positive line.

The other terminal of the switch 20 is coupled to the controller 13 via the GND terminal Tg. A line coupling the other terminal of the switch 20 to the controller 13 via the GND terminal Tg will be defined as a switch-signal negative line.

The controller 13 in this example performs determination of whether the switch 20 is switched on as determination of whether the switch signal has changed from an off level to an on level.

Accordingly, it is possible to isolate a situation where the switch 20 becomes stuck in the on mode, thereby achieving enhanced on/off determination accuracy of the switch 20. In particular, a situation where the relay 12 also becomes stuck in the on mode as the switch 20 becomes stuck in the on mode can be prevented, and erroneous power supply from the auxiliary-device battery 11 to the auxiliary device group 3 during the capacity-decrease cutoff control can be prevented.

In this example, the switch-signal supply unit 21 is configured to supply, to the controller 13, a signal based on a predetermined voltage value lower than the output voltage of the auxiliary-device battery 11 as the switch 20 is switched on. In detail, as illustrated in FIG. 2, the switch-signal supply unit 21 in this example includes a resistor Ru as a pull-up resistor coupled to the switch-signal positive line and a resistor Rd as a pull-down resistor coupled to the switch-signal negative line. Accordingly, the controller 13 can be supplied with the signal based on the predetermined voltage value lower than the output voltage of the auxiliary-device battery 11 when the switch 20 is switched on.

Although not illustrated, the resistor Ru as a pull-up resistor is coupled to a 12-V voltage that uses the auxiliary-device battery 11 as a power source.

In this example, in correspondence with the above-described configuration of the switch-signal supply unit 21, the controller 13 performs the determination of whether the switch 20 is switched on by determining whether the signal based on the aforementioned predetermined voltage value is supplied.

For example, if a set value for the aforementioned predetermined voltage value is 5 V, the controller 13 determines whether the voltage value of the supplied switch signal is 5 V. In this case, the determination is conceivably performed by defining a voltage range in which the predetermined voltage value can be regarded as 5V and determining whether the voltage value of the supplied switch signal is a value within the voltage range. In detail, if the set value for the predetermined voltage value is 5 V, for example, 4 V and 6 V are set as threshold values for the voltage range, and it is determined whether the voltage value of the supplied switch signal is within the range between 4 V and 6 V.

With the above-described configuration of the switch-signal supply unit 21 and the above-described method for determining whether the switch 20 is switched on, the switch 20 can be prevented from being erroneously determined as being in the on mode when the switch-signal supply line experiences a short circuit to ground. In one example, in the event of a short circuit to ground, the relay 12 can be prevented from becoming stuck in the on mode, and erroneous power supply from the auxiliary-device battery 11 to the auxiliary device group 3 during the capacity-decrease cutoff control can be prevented.

In this example, when a predetermined exceptional condition is satisfied, the controller 13 maintains the relay 12 in the off mode regardless of whether the switch 20 is in the on mode or the off mode.

In detail, in a state where the relay 12 is turned off, for example, when a predetermined exceptional condition that may lead to a battery malfunction, such as overcurrent, overcharging, high temperature, or over-discharging of the auxiliary-device battery 11, is satisfied, the controller 13 maintains the relay 12 in the off mode even if the switch 20 is switched on.

Accordingly, the auxiliary-device battery 11 can be prevented from malfunctioning, thereby achieving enhanced safety.

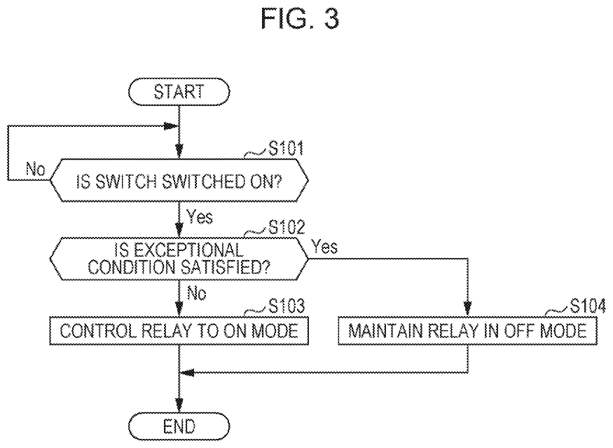

A specific processing example of the controller 13 will now be described with reference to a flowchart in FIG. 3.

The controller 13 executes the process illustrated in FIG. 3 in a state where the relay 12 is turned off.

First, in step S101, the controller 13 waits until the switch 20 is turned on. In detail, in this example, a switch signal based on the predetermined voltage value lower than 12 V is designed to be supplied in accordance with the aforementioned resistor Ru and the aforementioned resistor Rd when the switch 20 is switched on, so that the controller 13 performs determination of whether the switch signal has reached the predetermined voltage value as determination of whether the switch 20 is switched on (in detail, although the determination is performed using the two threshold values as mentioned above, details will be omitted to avoid redundant descriptions).

In this example, a change in the switch signal from the off level to the on level is included in the determination condition. Therefore, the controller 13 first determines in step S101 whether a change in the voltage value of the switch signal to the threshold value or more is detected, and determines whether the changed voltage value has reached the aforementioned predetermined voltage value lower than 12 V in accordance with the detection of the change.

If it is determined in step S101 that the switch 20 is switched on, the controller 13 proceeds to step S102 to determine whether an exceptional condition is satisfied. In detail, in this example, the determination of whether any of exceptional conditions, that is, the previously-mentioned overcurrent, overcharging, high temperature, and over-discharging of the auxiliary-device battery 11, is satisfied is performed.

If it is determined in step S102 that the exceptional condition is not satisfied, the controller 13 proceeds to step S103 to control the relay 12 to the on mode.

In contrast, if it is determined in step S102 that the exceptional condition is satisfied, the controller 13 proceeds to step S104 to maintain the relay 12 in the off mode.

Upon executing either of step S103 and step S104, the controller 13 ends the sequential process illustrated in FIG. 3.

The above description relates to an example where it is determined whether an exceptional condition is satisfied in accordance with the determination that the switch 20 is switched on. Alternatively, when the process for determining whether an exceptional condition is satisfied to determine that the exceptional condition is satisfied, the relay 12 may be maintained in the off mode without executing the determination of whether the switch 20 is switched on.

In either case, when the exceptional condition is satisfied, the relay 12 is maintained in the off mode as usual regardless of whether the switch 20 is in the on mode or the off mode.

Although a push-button switch or a knob switch is described above as an example where the switch 20 is a physical switch, such a button switch may impair the design depending on the installation location or may involve high costs for manufacturing the switch components. On the other hand, due to being a so-called emergency switch, the switch 20 is less frequently used relative to the life cycle of the vehicle.

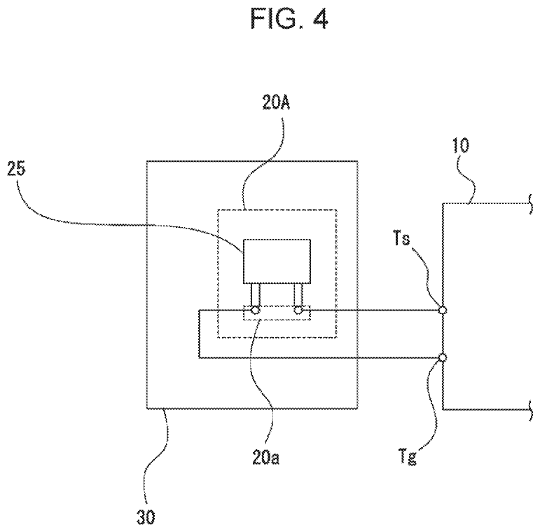

In view of this point, the switch 20 may conceivably be, for example, a switch 20A illustrated in FIG. 4 that is switchable between the on mode and the off mode by inserting and removing a fuse 25 within a fuse box 30 of the vehicle.

In detail, the switch 20A has a terminal unit 20a (at least including a positive terminal and a negative terminal) provided within the fuse box 30. By inserting and removing the fuse 25 into and out from the terminal unit 20a, the switch 20A is switched between the on mode and the off mode.

Accordingly, when the vehicle is to be provided with the switch 20, the design can be prevented from being impaired, and a spare fuse equipped in the vehicle can substitute for the fuse 25, thereby achieving cost reduction.

This embodiment is not limited to the specific example described above, and may allow various modifications.

For example, although a lithium-ion battery is used as the auxiliary-device battery 11 in the above description, the auxiliary-device battery 11 is not limited to a lithium-ion battery and may be any battery that may serve as a target for the capacity-decrease cutoff control.

Although the above embodiment of the disclosure is applied to an HEV in the above description, the embodiment of the disclosure may be applicable to a vehicle as a battery electric vehicle (BEV) not equipped with an engine or to a vehicle as an engine vehicle not having a drive motor and having an engine as a driving source for the wheels.

As described above, the vehicle power supply system (1) according to the embodiment of the disclosure includes the auxiliary-device battery (11) provided as a power source for the auxiliary device group in the vehicle, the relay (12) interposed between the auxiliary-device battery and the auxiliary device group, the controller (13) that controls the relay to the off mode in accordance with a decrease in the battery level remaining in the auxiliary-device battery and that performs the capacity-decrease cutoff control for cutting off the power supply from the auxiliary-device battery to the auxiliary device group, and the switch (20, 20A) switchable between the on mode and the off mode. The controller controls the relay to the on mode when the switch is detected as being switched on in a state where the relay is in the off mode.

Accordingly, even when the power supply to the auxiliary device group is stopped in accordance with the capacity-decrease cutoff control for protecting the auxiliary-device battery, the relay is forcibly turned on when the switch is switched on by the user, whereby electric power can be supplied to the auxiliary device group.

Therefore, a countermeasure against a dead battery can be prevented from being complicated even when a lithium-ion battery is provided as the auxiliary-device battery, and reduced maintainability can be prevented relative to when a lead battery in the related art is used.

In the vehicle power supply system according to the embodiment, the controller performs the determination of whether the switch is switched on as the determination of whether the switch signal indicating the on mode or the off mode of the switch has changed from the off level to the on level.

Accordingly, it is possible to isolate a situation where the switch becomes stuck in the on mode, thereby achieving enhanced on/off determination accuracy of the switch. In particular, a situation where the relay also becomes stuck in the on mode as the switch becomes stuck in the on mode can be prevented, and erroneous power supply from the auxiliary-device battery to the auxiliary device group during the capacity-decrease cutoff control can be prevented.

The vehicle power supply system according to the embodiment further includes the switch-signal supply unit (21) that supplies, to the controller, the signal based on the predetermined voltage value lower than the output voltage of the auxiliary-device battery as the switch is switched on. The controller performs the determination of whether the switch is switched on by determining whether the signal based on the predetermined voltage value is supplied.

Accordingly, the switch can be prevented from being erroneously determined as being in the on mode when the switch-signal supply line experiences a short circuit to ground. In one example, in the event of a short circuit to ground, the relay can be prevented from becoming stuck in the on mode, and erroneous power supply from the auxiliary-device battery to the auxiliary device group during the capacity-decrease cutoff control can be prevented.

In the vehicle power supply system according to the embodiment, when the predetermined exceptional condition is satisfied, the controller maintains the relay in the off mode regardless of whether the switch is in the on mode or the off mode.

Accordingly, when the predetermined exceptional condition that may lead to a battery malfunction, such as overcurrent, overcharging, high temperature, or over-discharging of the auxiliary-device battery, is satisfied, the supply of the electric power from the auxiliary-device battery to the auxiliary device group is not performed even if the switch is switched on.

Accordingly, enhanced safety can be achieved.

In the vehicle power supply system according to the embodiment, the switch (20A) is switchable between the on mode and the off mode by inserting and removing the fuse into and out from the terminal unit provided in the fuse box of the vehicle.

Accordingly, when the vehicle is to be provided with the switch, the design can be prevented from being impaired, and a spare fuse equipped in the vehicle can be used as a substitute, thereby achieving cost reduction.

The controller 13 illustrated in FIG. 2 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the controller 13. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 2.

1. A vehicle power supply system comprising:
an auxiliary-device battery provided as a power source for an auxiliary device group in a vehicle;
a relay interposed between the auxiliary-device battery and the auxiliary device group;
a controller configured to turn off the relay in accordance with a decrease in a battery level remaining in the auxiliary-device battery and perform capacity-decrease cutoff control comprising cutting off power supply from the auxiliary-device battery to the auxiliary device group; and
a switch switchable between an on mode and an off mode,
wherein the controller is configured to turn on the relay when the switch is detected as being switched on in a state where the relay is off, and
wherein the switch is configured to be switched between the on mode and the off mode by inserting and removing a fuse into and out from a terminal unit provided in a fuse box of the vehicle.

2. The vehicle power supply system according to claim 1,
wherein the controller is configured to determine whether the switch is switched on by determining whether a switch signal indicating the on mode or the off mode of the switch has changed from an off level to an on level.

3. The vehicle power supply system according to claim 1, further comprising:
a switch-signal supply unit configured to supply, to the controller, a signal based on a predetermined voltage value lower than an output voltage of the auxiliary-device battery as the switch is switched on,
wherein the controller is determine whether the switch is switched on by determining whether the signal based on the predetermined voltage value is supplied.

4. The vehicle power supply system according to claim 1,
wherein, when a predetermined exceptional condition is satisfied, the controller is configured to maintain the relay on regardless of whether the switch is in the on mode or the off mode.

5. A vehicle power supply system comprising:
an auxiliary-device battery provided as a power source for an auxiliary device group in a vehicle;
a relay interposed between the auxiliary-device battery and the auxiliary device group;
a switch switchable between an on mode and an off mode and configured to be switched between the on mode and the off mode by inserting and removing a fuse into and out from a terminal unit provided in a fuse box of the vehicle; and
circuitry configured to
turn off the relay in accordance with a decrease in a battery level remaining in the auxiliary-device battery and perform capacity-decrease cutoff control comprising cutting off power supply from the auxiliary-device battery to the auxiliary device group, and
turn on the relay when the switch is detected as being switched on in a state where the relay is off.
